(19) United States
(12) Patent Application Publication
(10) Pub. No.: US 2002/0023814 A1
(43) Pub. Date: Feb. 28, 2002

(54) Daul retractable cord device with sliding electrical connector

(76) Inventor: Andrew Poutiatine, Palo Alto, CA (US)

Correspondence Address: GARY CARY WARE & FREIDENRICH, 1755 EMBARCADERO, PALO ALTO, CA, 94303-3340, US

(21) Appl. No.: 09/797,445

(22) Filed: Feb. 28, 2001

Related U.S. Application Data
(60) Provisional application No. 60/185,877, filed on Feb. 29, 2000.

(51) Int. Cl. H02G 11/00

(52) U.S. Cl. 191/12.2 R

(57) ABSTRACT

A retractable cord device that includes a housing, a pair of electrical cords each having a first end disposed in the housing, a pair of winding spools rotatably mounted within the housing each having an annular cavity for winding one of the pair of electrical cords, and a pair of electrical connectors that are each attached to one of the pair of winding spools and are electrically connected to the first end of one of the electrical cords. The pair of electrical connectors are in sliding electrical contact with each other as the pair of winding spools rotate relative to each other.

### CROSS-REFERENCE TO RELATED APPLICATIONS

This application is a non-provisional application of Provisional Patent Application No. 60/185,877, filed Feb. 29, 2000, and a continuation-in-part application of U.S. Application No. 09/560,631, filed Apr. 28, 2000.

### BACKGROUND OF THE INVENTION

This invention relates to the field of devices that automatically retract and store a cable, such as a combination earphone/microphone cable that is used with a cellular phone, or a stereo headphone set that would be used with a portable radio or music player. Specifically, this device allows the extraction and retraction of a one-piece continuous electrical cord, without twisting the cord, where both ends may extract and retract independently.

### SUMMARY OF INVENTION

The retractable cord device of the present invention includes a housing, a first electrical cord having a first end disposed in the housing, a first winding spool rotatably mounted within the housing and rotatable about an axis, where the first spool has an annular cavity for winding the first electrical cord, a first electrical connector attached to the first winding spool and electrically connected to the first end of the first electrical cord, a second electrical cord having a first end disposed in the housing, a second winding spool rotatably mounted within the housing and rotatable about an axis, where the second spool has an annular cavity for winding the second electrical cord, and a second electrical connector attached to the second winding spool and electrically connected to the first end of the second electrical cord. The first electrical connector is in sliding electrical contact with the second electrical connector as the first winding spool rotates relative to the second winding spool.

In another aspect of the present invention, a retractable cord device includes a housing, a first electrical cord having a first end disposed in the housing, a first winding spool rotatably mounted within the housing and rotatable about a first axis, where the first spool has an annular cavity for winding the first electrical cord, a first electrical connector attached to the first winding spool and electrically connected to the first end of the first electrical cord, a second electrical cord having a first end disposed in the housing, a second winding spool rotatably mounted within the housing and rotatable about a second axis different from the first axis, where the second spool has an annular cavity for winding the second electrical cord, a second electrical connector attached to the second winding spool and electrically connected to the first end of the second electrical cord, and a third electrical connector disposed in the housing that is in sliding electrical contact with the first electrical connector as the first winding spool rotates about the first axis, and is in sliding electrical contact with the second electrical connector as the second winding spool rotates about the second axis.

### DEFINITIONS

A cable, or earphone cable (cord may also be used), is defined as a thin assembly of electrical conductors, each with insulation, surrounded by an insulating plastic jacket to keep the wires bundled together. The cross-section of the cord may be circular at the largest dimension, or it may be two adjacent circular cross-sections, similar in shape to the number 8. In the case of a cellular phone earphone/microphone combination cable, there are typically three separate circuits, microphone signal, earphone signal, and ground. In the cable, there may be separate wire bundles for the microphone and earphone ground circuits. In the case of audio stereo headphones, there are again typically three circuits, right channel, left channel and ground. There may again be separate wire bundles for the right and left ground.

### LIST OF DRAWING FIGURES

FIG. 1 shows an isometric view of the dual retractable device in its assembled, operational state.

FIG. 2 shows an inverted isometric exploded view of the dual retraction device.

FIG. 3A shows an isometric view of the outside of the bottom shell.

FIG. 3B shows an isometric view of the inside of the bottom shell.

FIG. 4A shows an isometric view of the outside of the top shell.

FIG. 4B shows an isometric view of the inside of the top shell.

FIG. 5A shows an isometric view of the top of the bottom spool.

FIG. 5B shows an isometric view of the bottom of the bottom spool.

FIG. 6A shows an isometric view of the bottom of the top spool.

FIG. 6B shows an isometric view of the top of the top spool.

FIGS. 7A and 7B show isometric views of the top and bottom of the printed circuit board.

FIG. 8 shows an isometric view of the spring retainer.

FIGS. 9A and 9B show isometric views of the top and bottom of the rocker buttons

FIG. 10 shows an orthographic hidden line view of the top spool, printed circuit board and rocker buttons.

FIG. 11 shows an exploded top isometric view of the top and bottom spools used in the cylindrical slip ring design.

FIG. 12 shows an exploded bottom isometric view of the top and bottom spools used in the cylindrical slip ring design.

FIG. 13 shows a cross-sectional view of the top and bottom spools used in the cylindrical slip ring design, in the assembled configuration.

FIG. 14 shows an isometric view of the dual retractable device with nested spools in its operational state.

FIG. 15 shows an exploded top isometric view of the top and bottom spools for the dual retractable device design with nested spools.

FIG. 16 shows an exploded bottom isometric view of the top and bottom spools for the dual retractable device design with nested spools.

FIG. 17 is an isometric view of the top and bottom spools in their assembled state, as used in the dual retractable device with nested spools.

FIG. 18 shows an isometric view of a dual retractable cord device in the side-by-side embodiment.

FIG. 19 shows an isometric exploded view from above of a dual retractable cord device in the side-by-side embodiment.

FIG. 20 shows an isometric exploded view from below of a dual retraction cord device in the side-by-side embodiment.

### PREFERRED EMBODIMENT

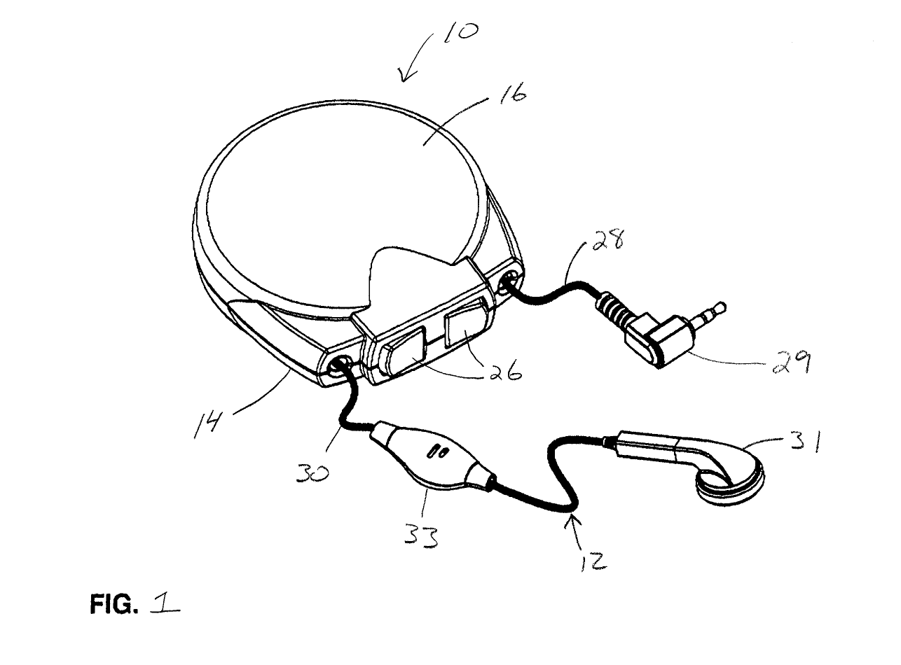

First the hardware for the dual retractable device will be described, then its operation. Referring now to FIG. 1, the dual retractable cord device 10 is shown in a state ready for use. Both sides of an earphone cable 12 are retracted. The earphone cable 12 is typically constructed out of wire bundles surrounded by an insulating wire jacket. The earphone cable 12 used in this embodiment also contains a bundle of aramid fiber filaments (not shown) that are included in the conducting wire bundle. The aramid fiber bundle takes the tensile load when the earphone cable is extracted under spring load.

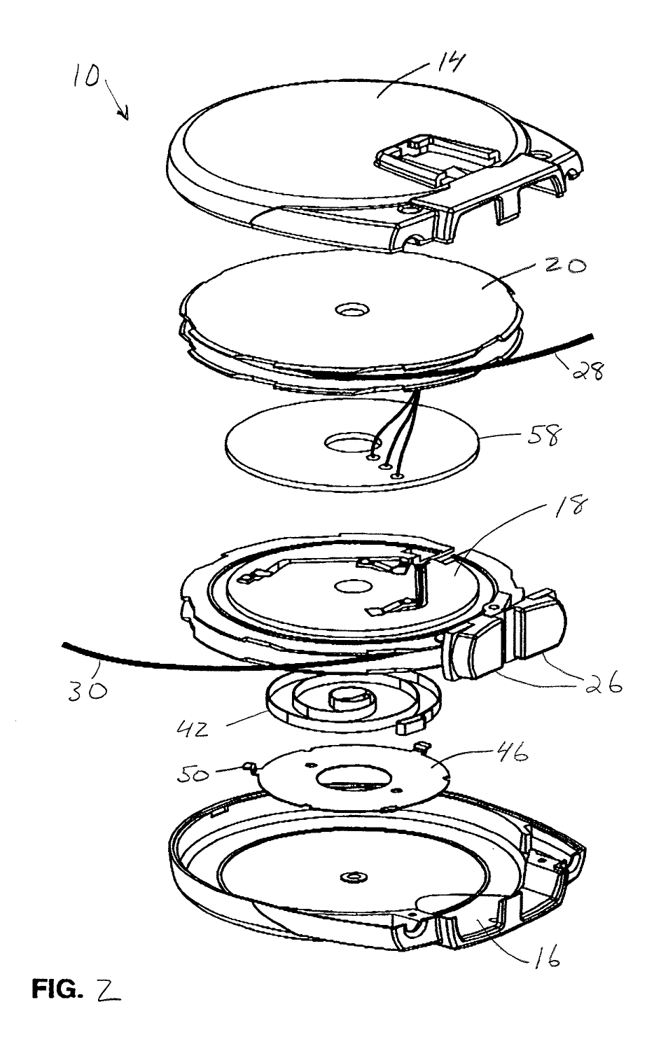

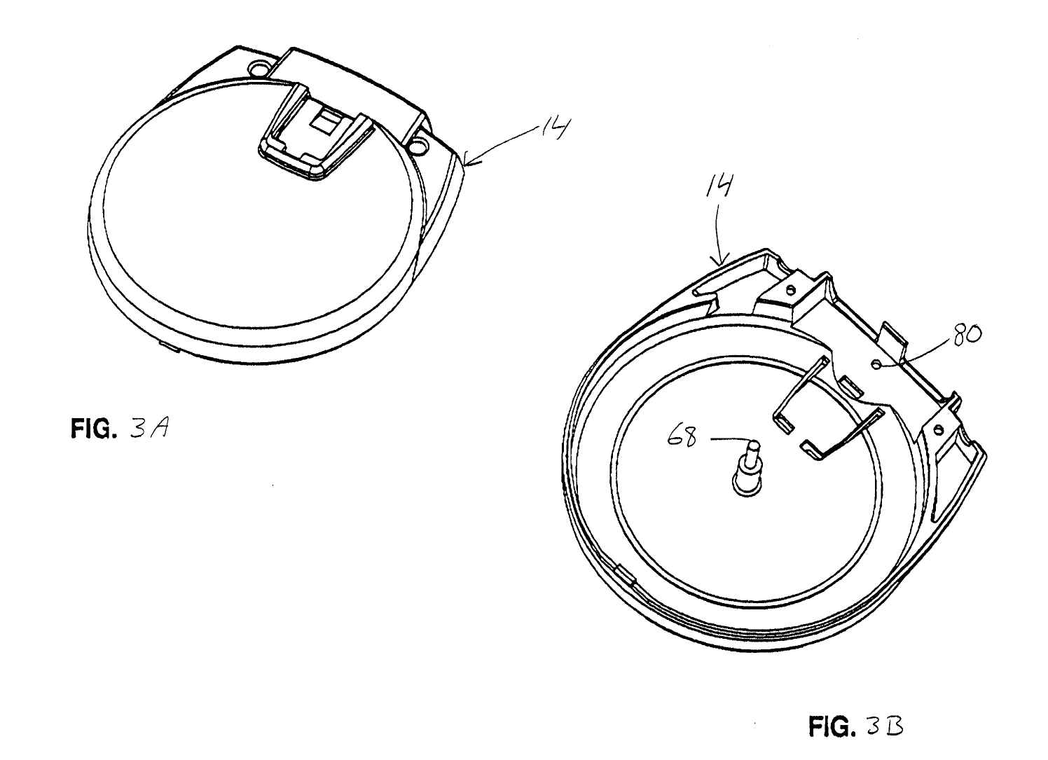

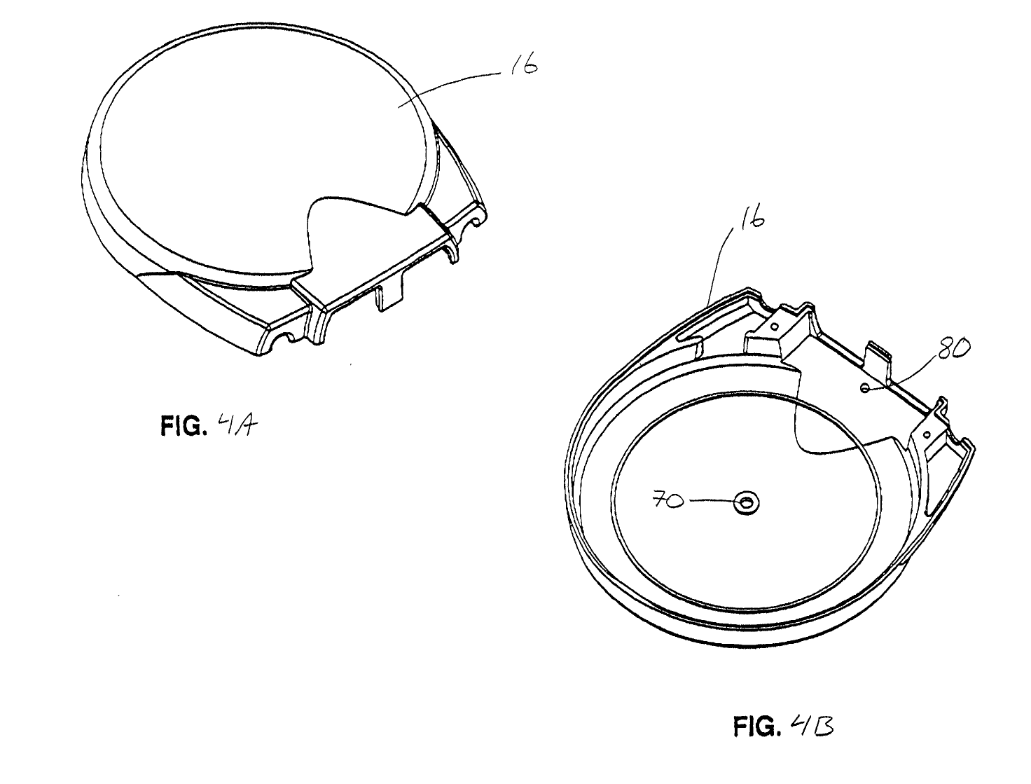

Referring now to FIG. 2, an exploded view shows the components used in the dual retraction device 10 in their relative configuration. There are two outer shell pieces, the bottom shell 14, which is best shown in FIGS. 3A and 3B, and top shell 16, which is best shown in FIGS. 4A and 4B. These shell pieces 14/16 are the outer housing that contains the retraction mechanism. The top and bottom shells 14/16 are fastened together by a combination of screws and molded in hooks and undercuts. The fastening method is not described in detail because this and other methods, such as a snap-fit, are well known in the field of plastic assembly design. Dual retraction device 10 includes top and bottom spools 18 and 20, the top and bottom shells 16 and 14, and rocker buttons 26, which are all injection-molded plastic parts. Injection-molding is well known in the field of accessory design. As shown in FIG. 1, cable 12 includes a length of cable 28 that is associated with the bottom spool 20 and has a connector 29 at one end, and a length of cable 30 that is associated with the top spool 18 and has an earphone 31 and a microphone 33 at one end.

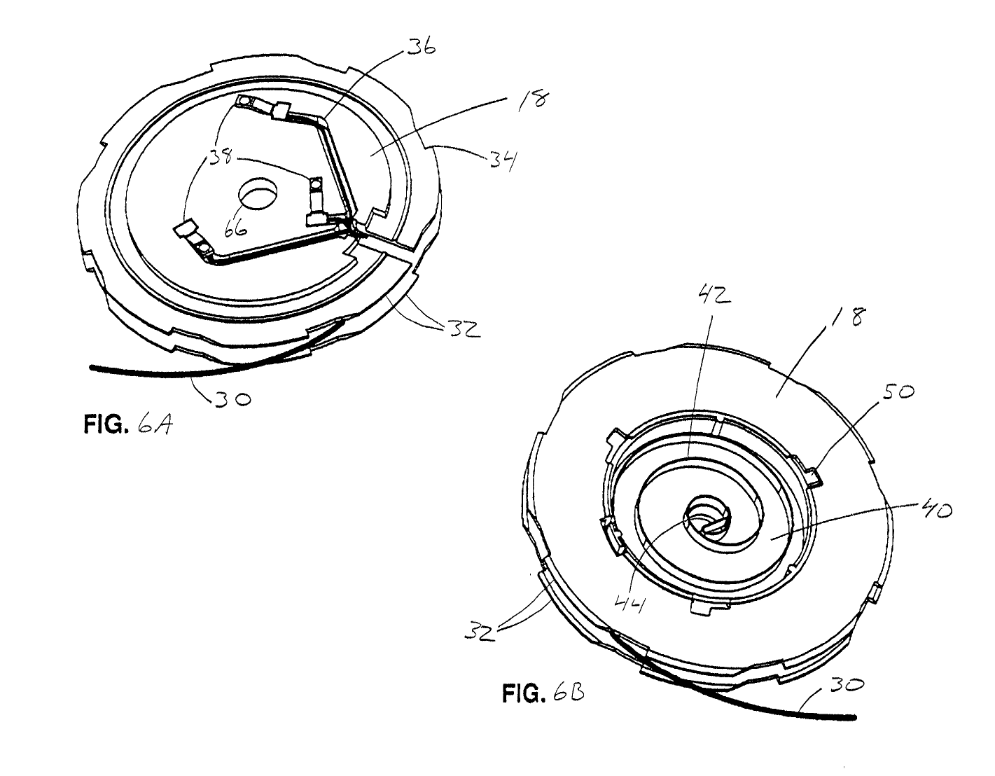

Referring to FIG. 6A, the top spool 18 has flanges 32 that allow a length of cable to be wound on it. The edges of the flanges 32 have ratchet teeth 34 molded in. FIG. 6A shows that the length of cable 30 that wraps around top spool 18 is fixed at a point where each of the circuits in the cable 30 is separated and routed in wire slots 36. Each of the wires in cable 30 terminate at a beryllium copper spring contact 38. The spring contacts are soldered onto end areas of the wires. The spring contacts 38 are heat-staked onto the top spool 18. Heat staking is a common method for fastening stamped metal components to molded plastic components. The beryllium copper spring contacts 38 are shaped and positioned such that they extend slightly above the top plastic surface of the top spool 18. The cable 30 is fixed near the point where it enters the wire slots 36 by being glued, to provide a strain-relief when the cable 30 is extracted all the way, by one of a variety of different methods. For example, the cable 30 could be fixed by running it through a serpentine path in the wire slot area 36. In the top spool subassembly, a continuous electrical connection is made between each of the three individual circuits beginning in the earphone and microphone, through the cable 30, and ending at the beryllium spring contacts 38.

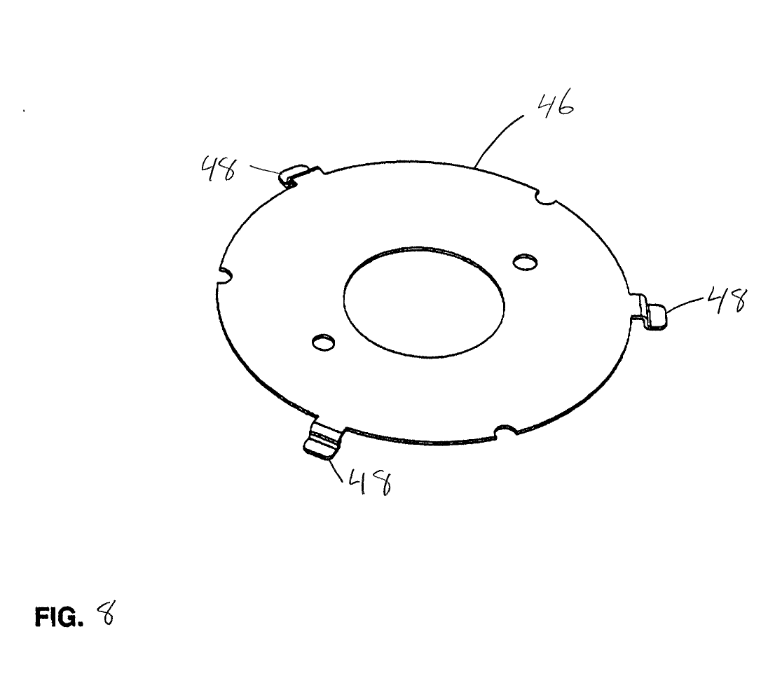

FIG. 6B shows a view of the opposite side of the top spool 18, showing a spring cavity 40 that contains the power spring 42. The power spring 42 is fixed at the outer wall of the spring cavity 40, where a small return 44 is bent into the end of the spring, and this return 44 is placed around a post. FIG. 2 shows that the power spring 42 is retained in the spring cavity 40 by a spring retainer 46, which is a stamped sheet metal piece, as illustrated in FIG. 8. Small tabs 48 on the spring retainer 46 align and snap into slots 50 on the top spool 18 to lock the spring retainer 46 into place.

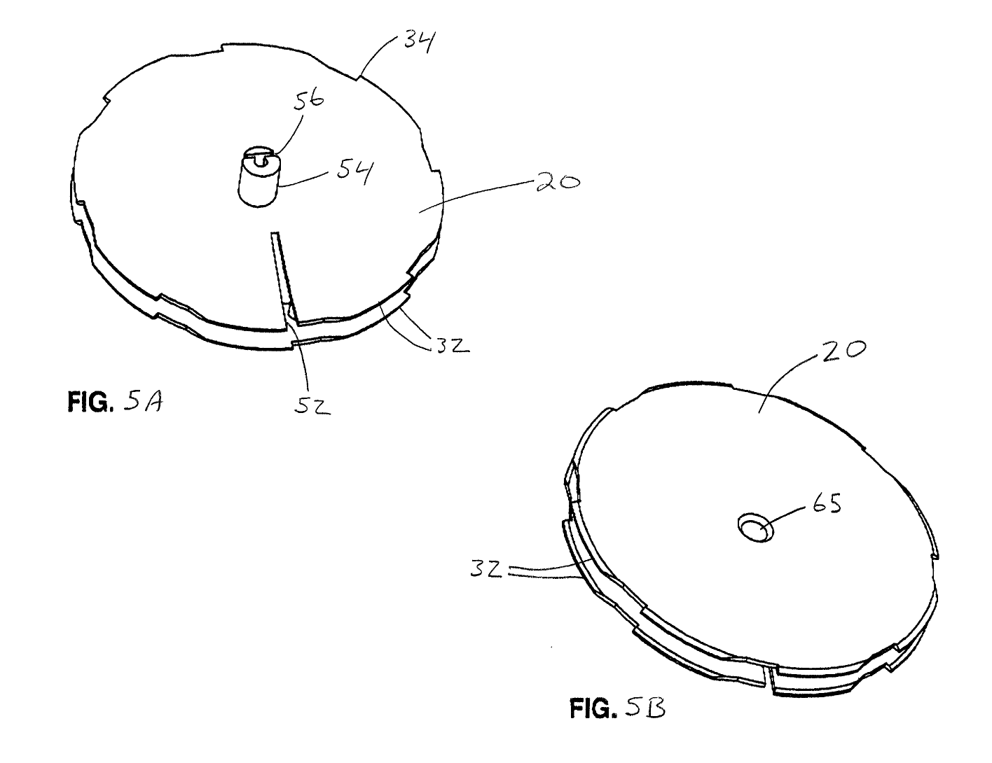

FIGS. 5A and 5B show alternate views of the bottom spool 20. The bottom spool 20 also has flanges 32 that allow a length of cable 28 to be wound and retained on the spool 20. The flanges 32 on the bottom spool 20 also include ratchet teeth 34. FIG. 5A shows that one side of the bottom spool includes a wire slot 52. The connector end of the cable 28 is fixed at a point where the cable 28 exits the spool winding space (cavity) between the flanges 32, at the wire gap. The cable 28 has been omitted in FIG. 5A for the purpose of clarity. FIG. 5A also shows that the bottom spool 20 has an axle 54 protruding from one side. The axle 54 has a molded-in spring slot 56.

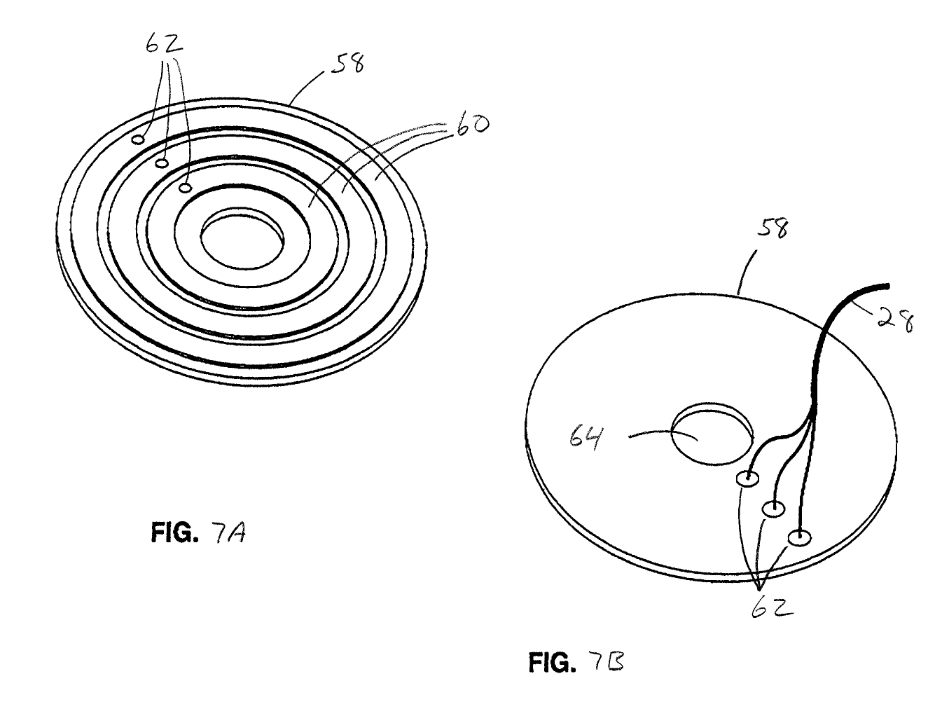

FIG. 7A and 7B show a printed circuit board 58, which is manufactured out of fiberglass composite board called FR-4. This material and the technology to manufacture the printed circuit board are well known in the field of accessory design. FIG. 7A shows that one side of the printed circuit board 58 has three concentric circular copper traces 60. Each of these circular copper traces 60 has a plated through hole 62. FIG. 7B shows that the plated through holes 62 on the other side are filled with solder, creating conductive solder pads 62 on the printed circuit board 58. Soldered to each of the conductive pads 62 is one of the wire bundles that make up the connector side of the cable 28.

FIG. 2 shows the orientation and placement of the printed circuit board 58 and the bottom spool 20. The side of the printed circuit board 58 with the wires extending from it faces the bottom spool 20. When the printed circuit board 58 is attached to the bottom spool 20, the solder pads 62 with the wires attached are aligned with the wire slot 52, so there is no gap between the top surface of the bottom spool 20 and the printed circuit board 58. The printed circuit board 58 and bottom spool 20 are fixed together in this embodiment, by being glued together, thus, they rotate together. Glue is also used to pot the wires of cable 28 at the wire slot 52, providing strain relief so that a tensile load is not transferred to the solder joints when the cable 28 is pulled all the way out. The bottom spool 20 and the printed circuit board 58 are aligned on their axes of rotation because the hole 64 in the center of the printed circuit board fits onto the axle 54 on the bottom spool 20. The bottom spool 20 and the printed circuit board 58 could be fixed in other ways, such as by being heat-staked together. Or there could be holes or slots on the printed circuit board 58 and corresponding pegs molded into the bottom spool 20 that interlock and prevent the two components from moving independently.

Referring again to FIG. 2, the top spool subassembly includes the earphone 31 and microphone 33 attached to the length of cable 30 that is wound around the top spool 18, with the individual circuits in the cable 30 terminated by being soldered to the beryllium spring contacts 38, and the power spring 42 held in the spring cavity 40 by the spring retainer 46, and the top spool 18 itself. The bottom spool subassembly includes the connector 29 attached to the length of cable 28 that is wound around the bottom spool 20, soldered to the solder pads 62 on the printed circuit board 58, with the bottom spool 20 glued to the printed circuit board 58.

The bottom spool subassembly is placed against the top spool subassembly so that each of the three spring contacts 38 fixed to the top spool 18 are flexibly forced against a corresponding concentric conductive trace 60 on the printed circuit board 58. The spring rate of the spring conductors 38 is such that there is very little friction and the rotation of the spools 18/20 is not impeded, as driven by the spring 42. The top spool subassembly and the bottom spool subassembly are held together in this configuration by the top shell 16 and bottom shell 14. The axle 54 protruding from the bottom spool 20 extends through the hole 66 in the top spool 18, insuring that the two subassemblies are aligned on, and rotate on, the same axis. Likewise, the spindle 68 shown in FIG. 3B protruding from the bottom shell 14, extends through the hole 65 in the bottom spool 20, ensuring that the whole assembly is constrained to rotate on axis within the housing made by the top and bottom shells 16/14. The spindle 68 is captured in a spindle journal 70 that is molded into the top shell 16, shown in FIG. 4B. When the top spool subassembly and the bottom spool subassembly are placed together, there is a continuous circuit made from each of the circuits that connect to the earphone 31 and microphone 33, through each conductive circuit wire bundle in the cable 30 wound on the top spool 18, through the spring contacts 38 attached to the top spool 18, through the circular conductive traces 60 (because the spring contacts 38 are in forced contact with the circular traces 60), through the solder pads 62 on the circuit board 58, and into the corresponding circuit wire bundle in the cable 28 wound on the bottom spool 20, and terminating at the contacts in the connector 29.

Referring again to FIG. 6B, the end of the power spring 42 that is in the center of the coiled spring 42 has an end condition which is a bent loop (return) 44 with a straight section. When the dual retraction device is assembled and the top spool subassembly is placed adjacent to the bottom spool subassembly, the axle 54 on the bottom spool 20 protrudes through the center hole 66 on the top spool 18 into the spring cavity 40. The power spring 42 is given a pre-load, that is, it is rotated approximately 360 degrees in the direction that tightens the spring 42, and the straight section of return 44 on the power spring 42 is placed into the spring slot 56 on the axle 54.

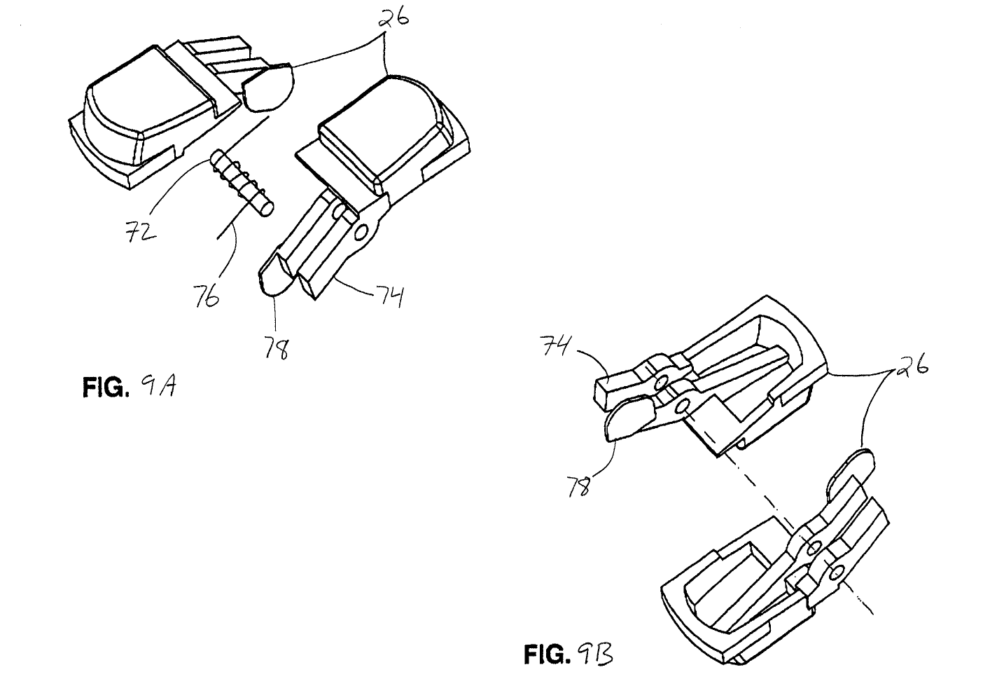

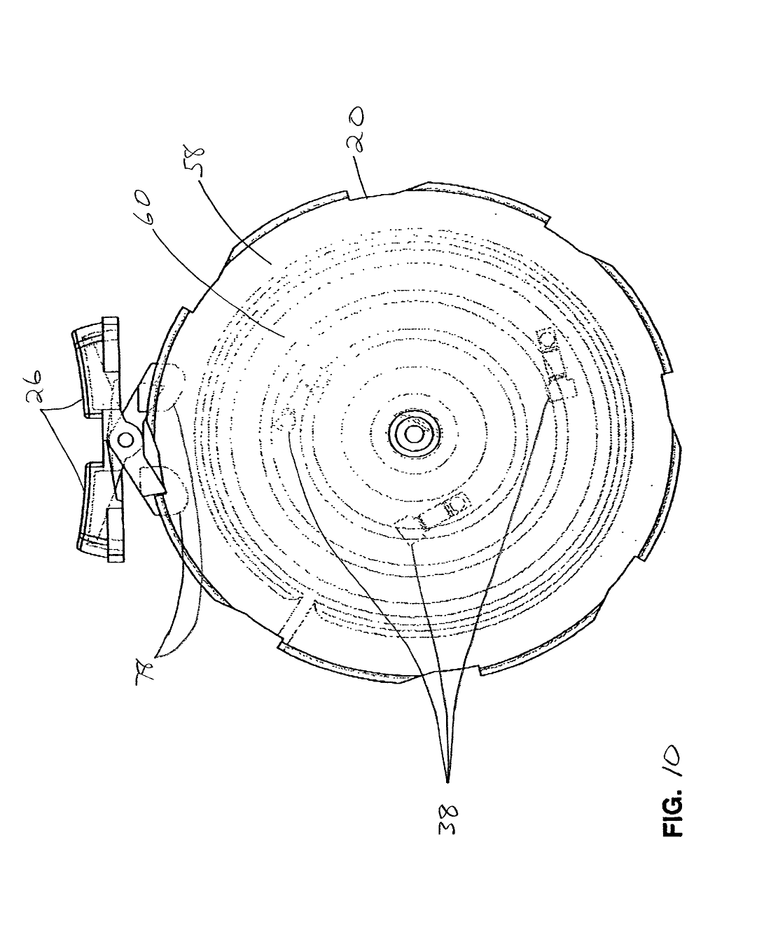

Referring now to FIGS. 9A and 9B, the rocker button subassembly is shown. The rocker buttons 26 are two identical parts that are combined together on a dowel pin 72 and added to the assembly, as shown in FIG. 2. The rocker buttons 26 have ratchet arms 74 whose purpose it is to engage with the ratchet teeth 34 on the spool flanges 32. As shown in FIG. 9A, there is also a torsion spring 76 that is placed on the dowel pin 72 so that it acts to keep the pointed ends of the rocker button ratchet arms 74 engaged with the ratchet teeth 34 on the respective spools 18/20, as shown in FIG. 10. Referring to FIGS. 9A, 9B and 10, there are guide webs 78 at the end of one of the ratchet arms 74 on each button 26, the purpose of which is to keep the ratchet arms 74 in line with the flanges 32 on the spools 18/20. When assembled, the guide webs 78 are positioned between the two appositioned faces of the top spool 18 and the bottom spool 20. The dowel pin 72 is constrained between the top and bottom shells 16/14 by extending into molded journals 80, shown in FIGS. 3B and 4B.

Next, the operation of the dual retractable cord device will be described. As stated above, the bottom-spool subassembly, the top spool subassembly and the rocker button subassembly are combined as shown in FIG. 2. They are contained by the top shell 16 and by the bottom shell 14. When assembled and in the fully retracted state, the connector side cable 28 is wound completely around the bottom spool 20 such that a small length of cable 28 extends out of the dual retractable device 10, as shown in FIG. 1. Likewise, the earphone/microphone side cable 30 is completely wound around the top spool 18 so that only the earphone 31, the microphone 33 and a small length of cable 30 extend from the dual retractable device 10. In the fully retracted mode, the power spring 42 that connects the top spool subassembly and the bottom spool subassembly is almost fully unwound. There is a small amount of pre-load in the power spring 42, so that the spools 18/20 are being slightly driven to pull the two cable lengths 28/30 into the unit. The pre-load is such that the retraction of the two lengths of cable 28/30 into the unit are stopped when the connector 29 and the microphone 33 are pulled up against the dual retractable device housing.

Both lengths of cable 28/30 can be extracted from the housing independently, to various independent lengths, simply by pulling on the cables 28/30. Regardless of the length of extraction of either side, electrical contact is maintained through the circuits leading from the earphone 31 and microphone 33, to the connector 29, because of the spring contacts 38 riding (sliding) on the circular traces 60. In the mode where both cables 28/30 are pulled out as far as they will go, the power spring 42 is wound up to its fully wound state, and is applying a torque to both the top spool 18 and bottom spool 20 to rotate and retract the cables 28/30. Extraction is limited by the length of each side of the cables 28/30, and by the fact that each cable 28/30 is fixed at a strain relief, at each of the top and bottom spools 18/20. As shown in FIG. 10, it is the engagement of the ratchet arms 74 with the ratchet teeth 34 on the spool flanges 32 that prohibits the rotation of the spools 18/20. Because of the ramped rear side 82 of the ratchet teeth 34 on the spool flanges 32, the cables 28/30 can be extracted. During extraction, the ratchet arms 74 ride up the ramped edge 82 of the ratchet teeth 34 and snap back down into the ratchet teeth cavities as the spool rotates. However, when extraction is ceased, the power spring 42 drives each of the spools 18/20 to rotate so that both of the cable ends are retracted. But each spool 18/20 can only rotate back a fraction of a turn until the ratchet arms 74 are forced, by the torsion spring 76 on the rocker buttons 26, down into the space created by the ratchet teeth 34. In this direction, the flat faces of the ratchet arms 74 are forced against the flat edge of the ratchet teeth 34, prohibiting further rotation of the spools 18/20. Each of the spools 18/20 can be independently released for full or partial retraction by pressing the corresponding rocker button 26, causing the rocker button 26 to rotate on the dowel pin 72 against the force of the torsion spring 76. This in turn causes the ratchet arm 74 to be rotated away from the edge of the ratchet tooth 34. Either of the bottom spool 20 or top spool 18, depending on which corresponding rocker button 26 is depressed, is free to rotate to retract the corresponding cable 28 or 30. This rotation is driven by the power spring 42.

### FIRST ALTERNATIVE EMBODIMENT—CYLINDRICAL SLIP RING

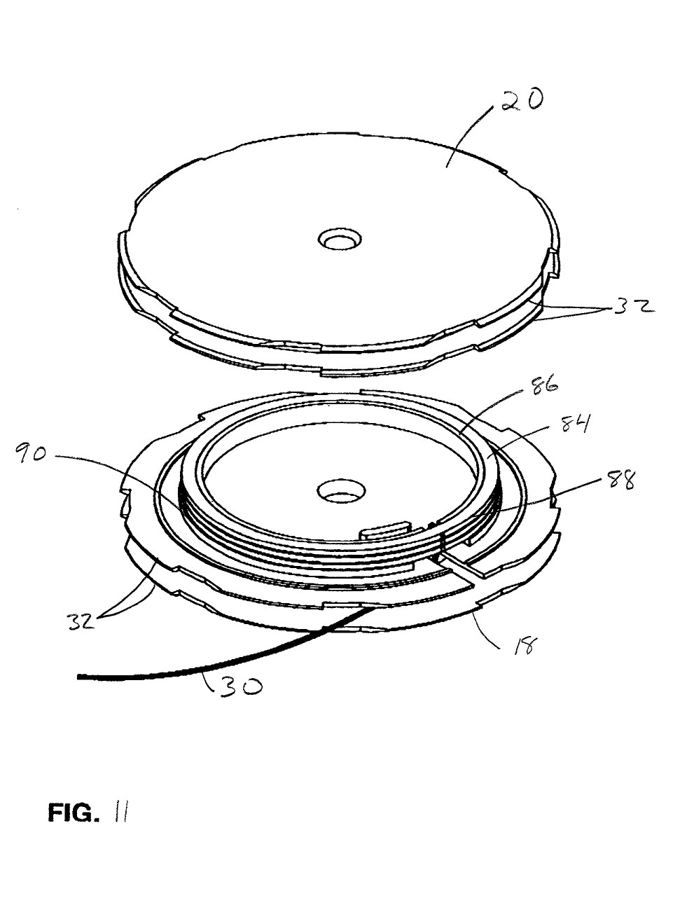

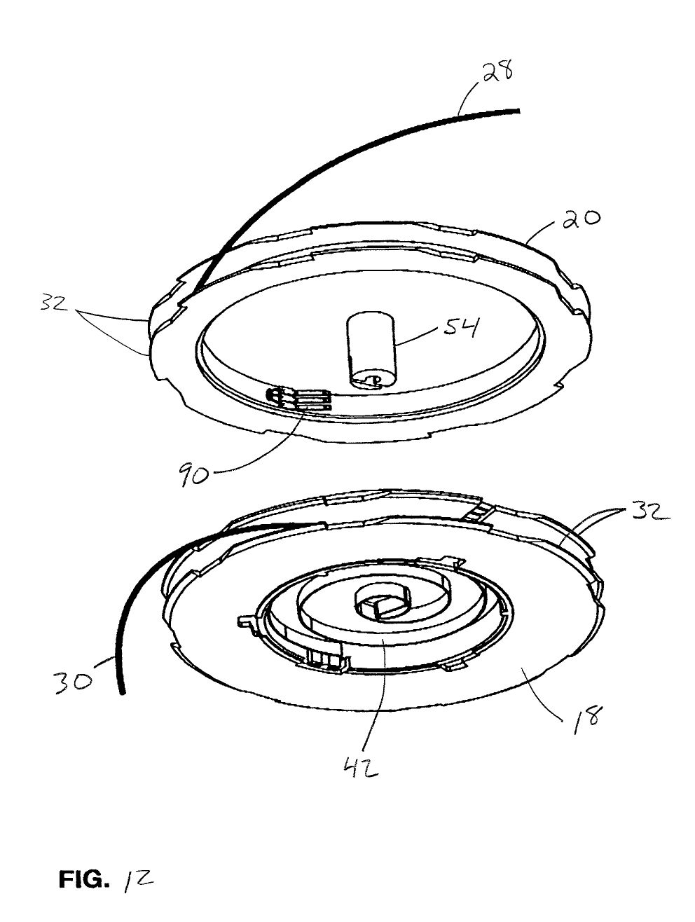

FIG. 11 and 12 show a design for a dual retractable cord device similar to the preferred embodiment, however in this embodiment, the slip ring rotating contact system uses a cylindrical circuit board that is attached to the top spool and that nests in the bottom spool. The concept for the containment and rotation of the spools inside a molded housing is the same as in the preferred embodiment. Also the method for controlling the extent to which either side of the cable is extracted is also the same, where rocker buttons with ratchet arms engage with ratchet teeth molded onto the outer edge of the spool flanges.

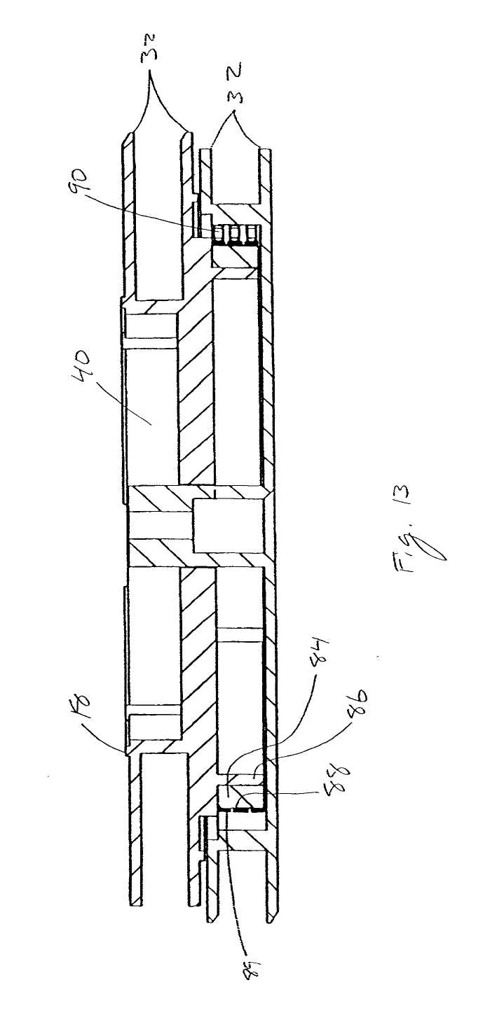

The top spool 18 includes a circuit cylinder 84, a cylindrical plastic piece that press fits against a cylindrical wall 86 that is integral to the top spool 18. The circuit cylinder 84 is best shown in place in FIGS. 11 and 13. Wrapped around the circuit cylinder 84 is a strip of flexible circuit material 88, which is a laminate with a kapton substrate and copper circuit traces 89. Flexible circuit technology is well known and will not be described here in detail. The flexible circuit 88 is very thin and is glued to the outer surface of the circuit cylinder 84, as shown in FIG. 11. There are three annular traces 89 created by the application of the flexible circuit to the cylindrical wall feature. The three wire bundles from cable 30 are soldered to three corresponding through holes that are die cut in the flexible circuit and electrically connected to the three traces 89. The wires are also strain-relieved at the solder point by being potted with glue, so that the solder joints are not resisting tensile loads when the cable 30 is extracted from the spool 18.

FIG. 12 shows that the three wire bundles from cable 28 are soldered to three separate beryllium spring contacts 90 that are heat-staked against the inside wall of the bottom spool. The wires extend into this chamber through a hole in the wall. The wire is potted at this hole with glue, which provides a strain-relief against tensile loads when the cable 28 is extracted.

The spring contacts 90 attached to the bottom spool 20 extend in toward the center of the spool 20 such that when the two spools 18/20 are mated, as shown in FIG. 13, each of the spring contacts 90 are forced against a corresponding annular circuit trace 89. With this system, a continuous circuit is maintained between the functional terminals of the earphone 31 and microphone 33 signals and ground, through the cable 30, through spring contacts 90 and traces 89 and cable 28, and to terminals that exist on the connector 29. This continuous circuit is maintained regardless of the length of extraction of either side of the cables 28/30.

### SECOND ALTERNATIVE EMBODIMENT—NESTED SPOOLS

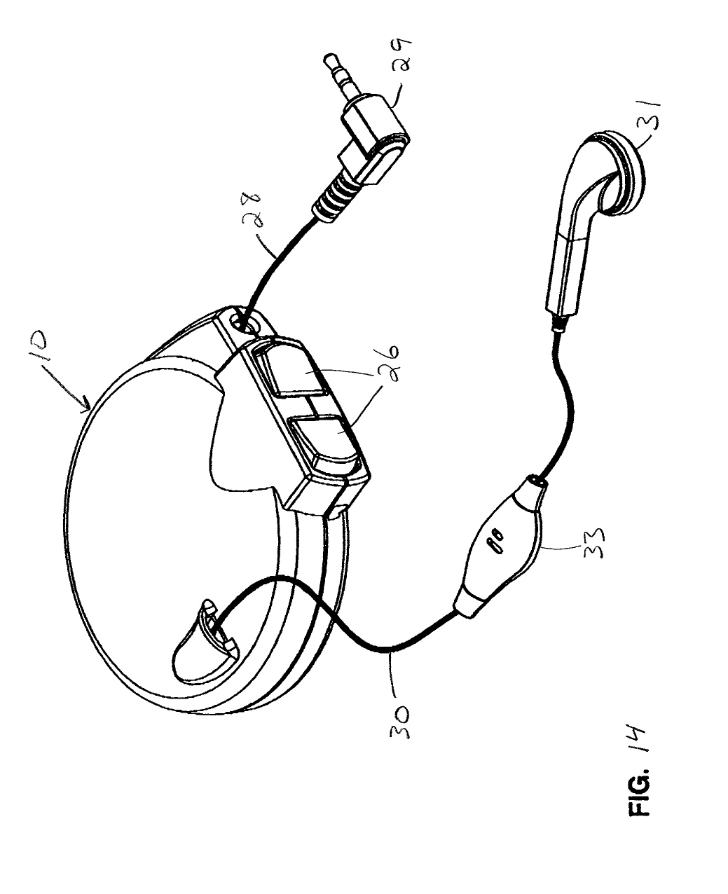

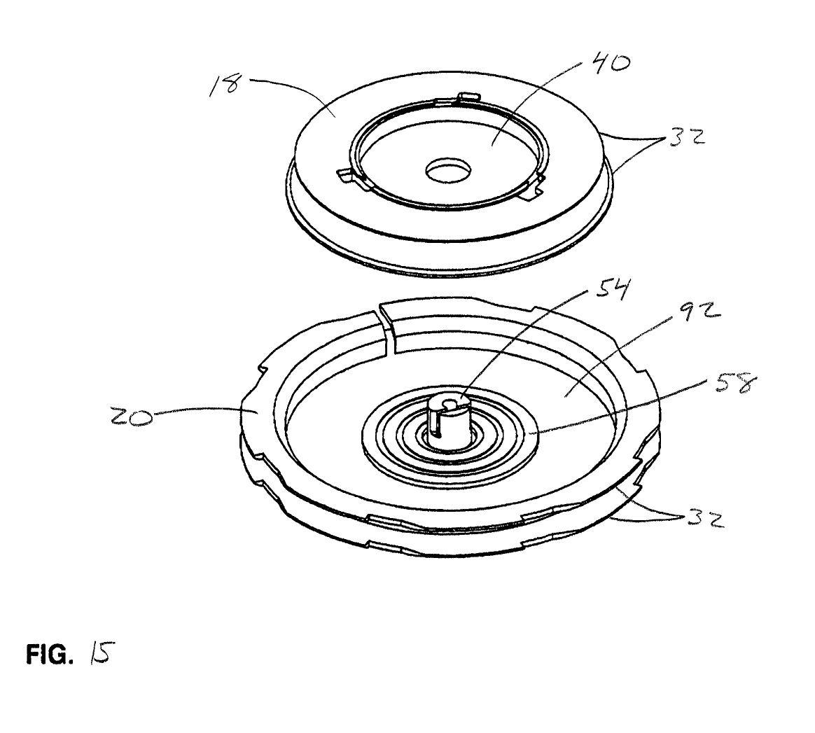

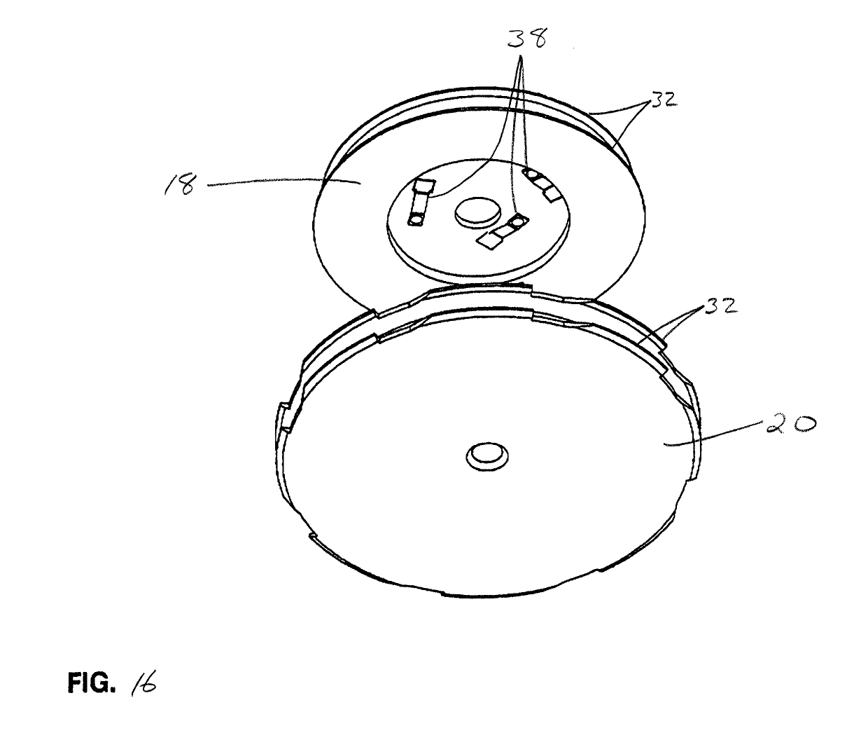

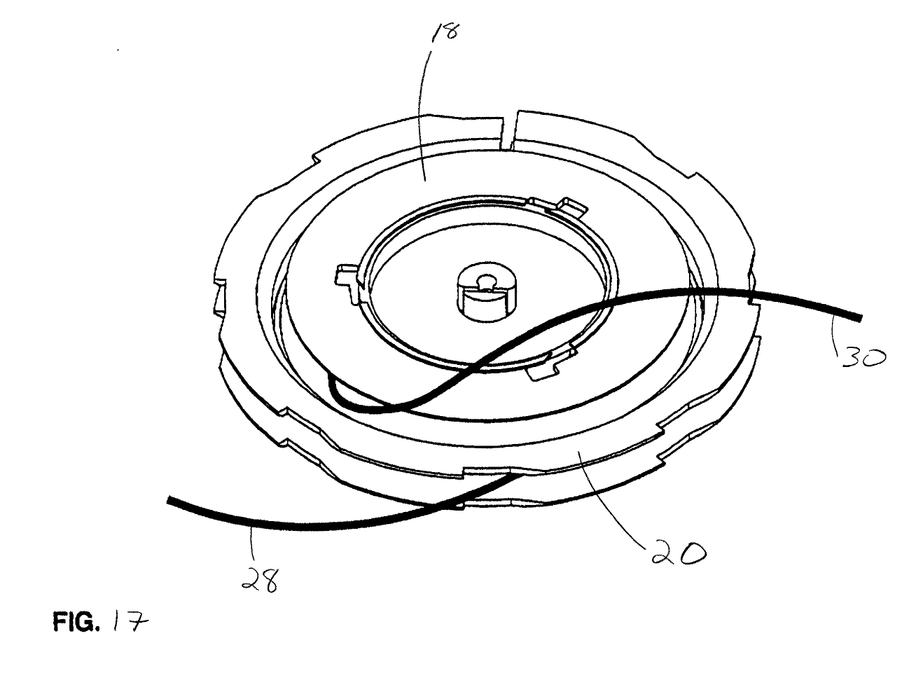

Referring now to FIG. 14, a variation on the dual retractable design is shown in its operational state, where the entry of earphone/microphone cable 30 into the device is located in top shell 16, rather than alongside the rocker buttons 26 as in the other embodiments. FIG. 17 shows the design with just the top and bottom spools 18/20. The top spool 18 is nested inside the bottom spool 20 and the earphone/mic cable 30 exits the spool assembly through the space between the top spool flange 32 and the inner wall of the bottom spool 20. The top spool 18 would also have ratchet teeth that are not shown in FIG. 17. FIGS. 15 and 16 show the top and bottom spools 18/20 exploded so that the features of each part and their assembly orientation can be shown. A printed circuit board 58 is placed into the bottom spool 20, at the bottom of the cavity 92 that nests the top spool 18. On the surface of the top spool 18 that faces the bottom spool 20 there are three beryllium spring contacts 38 that are heat-staked to the top spool 18. The individual wire bundles that make up the cable 30 that connects to the earphone 31 and microphone 33 are routed and soldered to these contacts 38. The routing and soldering of these cables is similar to method shown in previous embodiments and is not shown here so as not to obscure the present invention. The wires from the connector cable 28 likewise are routed and soldered to the printed circuit board 58. Again, these wires are not shown so as not to obscure the present invention. The independent retraction and extraction of cables 28/30 are also controlled by a set of rocker buttons 26 that are similar in function to the rocker buttons 26 shown in the preferred embodiment, except that the rocker buttons in this embodiment are not symmetrical as in the previous embodiments. The rocker button 26 that is associated with the top spool 18 has a ratchet arm 74 that extends in to connect with the ratchet teeth 34 along the top flange 32 of the top spool 18.

### THIRD ALTERNATIVE EMBODIMENT—SIDE-BY-SIDE SPOOLS

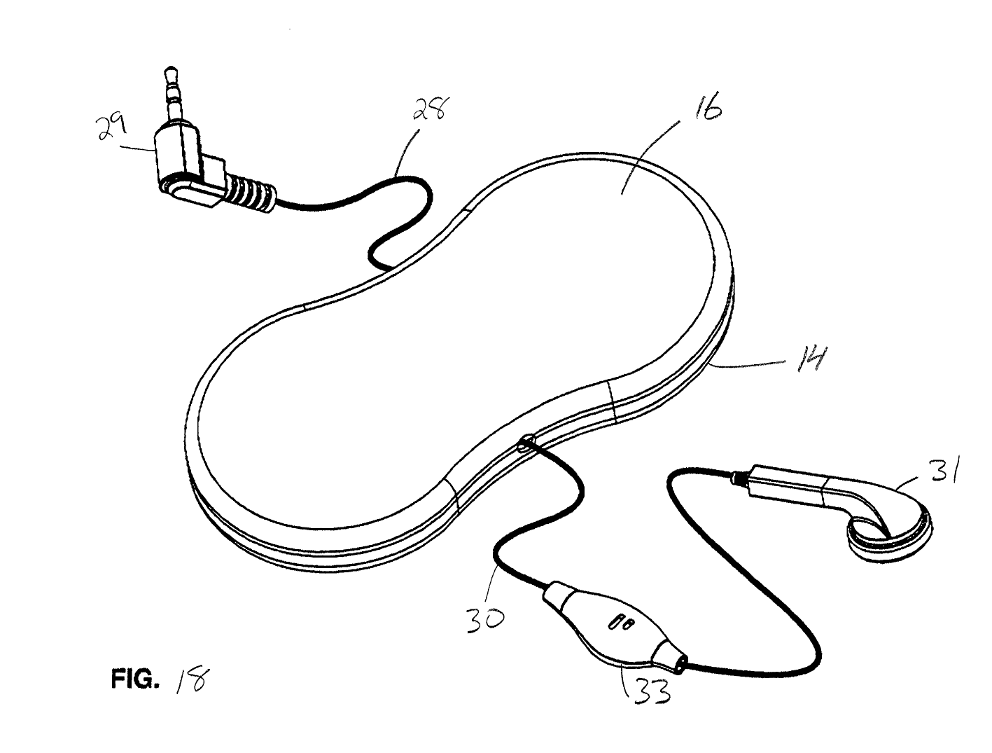

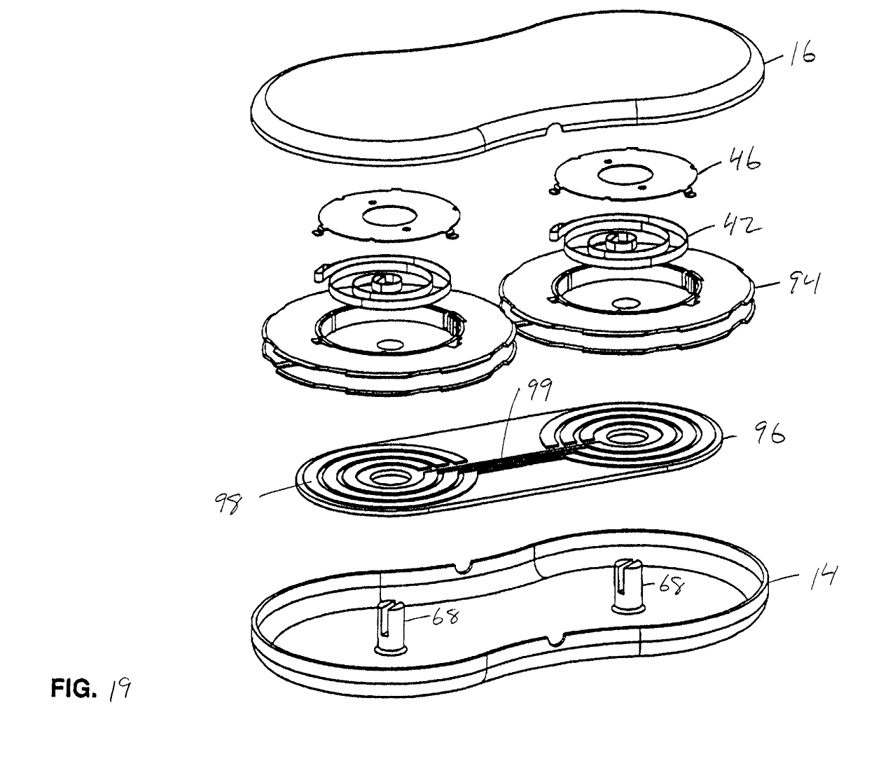

FIG. 18 shows an embodiment of the dual retractable cord device 10 that has the spools positioned in a side-by-side configuration. FIG. 18 shows where the two cables 28/30 enter the housing. FIG. 19 shows an exploded view of the side-by-side embodiment. There are two identical spool subassemblies; each subassembly includes a spool 94, a power spring 42, a stamped metal spring retainer 46 and three stamped beryllium copper spring contacts 38. The assembly details of the components are the same as the earlier embodiments, and spools 94 are essentially the same as top spool 18 from the first embodiment. The spring contacts 38 are heat-staked to the spools 94. The entire assembly is contained in a housing made up of the top and bottom shells 16/14. The two spools 94 rotate on the two spindles 68 that are integrally molded into the bottom shell 14. Each of the spools 94 includes flanges 32 with ratchet teeth 34, so that the rocker buttons 26 work in the same manner as in the previous embodiments. The rocker buttons 26 and related components have been omitted so as not to obscure the present invention.

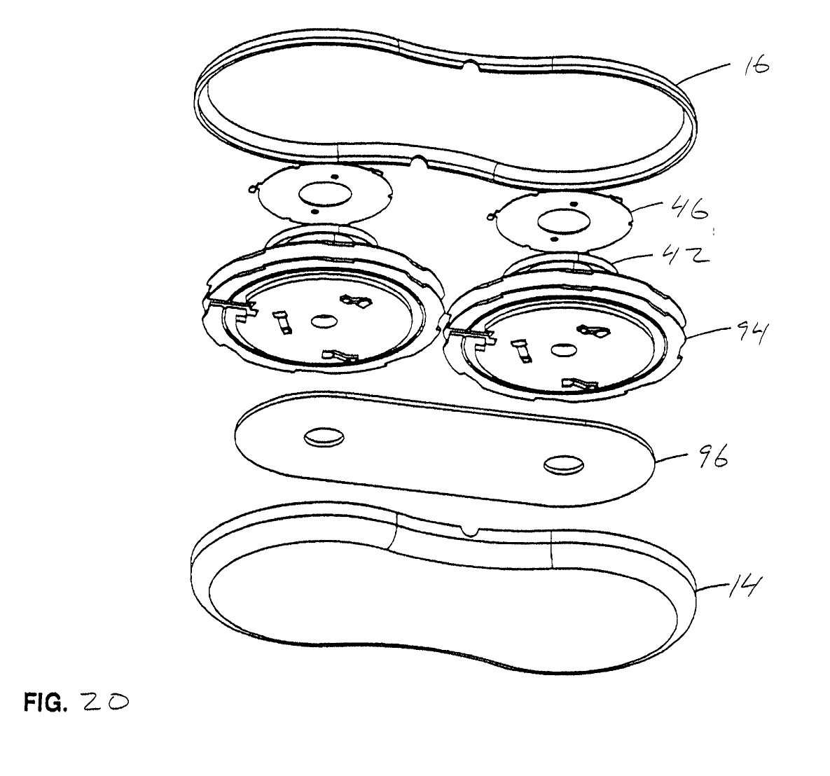

FIGS. 19 and 20 show that there is a one piece printed circuit board 96 having two sets of identical circular concentric conductive traces 98. These traces 98 are connected together by linear traces 99 that run between the two sets of circular traces 98. The circular traces 98 are split to allow the linear traces 99 to connect the two sets of circular traces 98 without shorting to another circuit. The circular traces 98 could also be connected by having plated through holes that route the circuits to the other side of the printed circuit board 96.

The two spools 94 are positioned so that the spring contacts 38 are in slight forced contact with the concentric circular conductive traces 98 on the circuit board 96. When either of the cables 28/30 is extracted, the corresponding power spring 42 is wound up and exerts a force to rotate the spool 94 to retract the cable 28/30. The rocker buttons 26 act to limit this retraction, as in the previously disclosed embodiments. A continuous electrical contact is made between the components in the earphone 31 and microphone 33, through the cable 30, through the spring contacts 38 and circular traces 98, through the other cable 28, and on to the terminal contacts at the connector

What is claims is:

1. A retractable device comprising, in combination,
at least a first electrical connector cord having an element at one end,
at least a first winding spool rotatably mounted within said housing and rotatable about said axis, said spool having an annular peripheral cavity for winding said first connector cord,
a spring urging said winding spool to wind said first connector cord in said peripheral cavity of said spool,
said housing having a first opening for passing said first connector cord of said housing on a path substantially tangential to said annular cavity and with said element outside said housing, and
means within said housing for providing sliding electrical contact to the other end of said first connector cord.

2. A retractable earphone cord device comprising, in combination,
a housing,
an earphone cord having an earphone at one end,
a connector cord having a connector at one end,
a first winding spool rotatably mounted within said housing to wind said earphone cord in an annular peripheral cavity of said first spool,
a second winding spool mounted within said housing to wind said connector cord in an annular peripheral cavity of said second spool,
spring means urging said first and second winding spools to wind said earphone cord in said peripheral cavity of said first spool and said connector cord in said peripheral cavity of said second spool,
opening means in said housing for passing said earphone cord and said connector cord out of said housing,
means for fixing the other ends of said earphone cord and said connector cord respectively to said first and second winding spools, and
means for providing sliding electrical contact between said other ends of said first and second winding spools.
